(19) United States
(12) Patent Application Publication
(10) Pub. No.: US 2025/0274466 A1
(43) Pub. Date: Aug. 28, 2025

(54) CYBERSECURITY ALERT RESPONSE CHATBOT VIA LARGE LANGUAGE MODELS AND NATURAL LANGAUGE ALERT DESCRIPTORS

(71) Applicant: Palo Alto Networks, Inc., Santa Clara, CA (US)

(72) Inventors: Krishnan Shankar Narayan, San Jose, CA (US); Venkata Ramadurga Prasad Katakam, Sunnyvale, CA (US); Preyansh Shah, Hayward, CA (US)

(21) Appl. No.: 18/589,847

(22) Filed: Feb. 28, 2024

(51) Int. Cl. H04L 9/40; G06F 40/40

(52) U.S. Cl. CPC H04L 63/1425; G06F 40/40; H04L 63/102; H04L 63/105

(57) ABSTRACT

As cybersecurity alerts are detected and logged as formatted descriptors across an organization, a text converter converts the formatted descriptors into natural language descriptors by extracting and inserting metadata fields into natural language templates corresponding to user personas for the organization. In response to an alert-based query from a user, a persona classifier predicts a persona of the user from historical chat logs and retrieves natural language descriptors for alerts related to the user and predicted persona. A prompt generator receives the retrieved natural language descriptors and generates a prompt that instructs a large language model (LLM) to respond to the user with data from the natural language descriptors. Once prompted, the LLM establishes a conversation with the user via an interface for alert resolution.

### BACKGROUND

The disclosure generally relates to data processing (e.g., CPC subclass G06F) and to computing arrangements based on specific computational models (e.g., CPC subclass G06N).

Chatbots are commonly employed to provide automated assistance to users by simulating human conversation via chat-based interactions. Example use cases for chatbots include handling customer inquiries, automating tasks, providing information, and delivering recommendations. Chatbots are increasingly implemented using artificial intelligence (AI) to handle and respond to natural language inputs from users, with implementations rapidly adopting generative AI for text generation.

A multitude of generative AI technologies are built upon transformer models. The “Transformer” architecture was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a foundational model and there has been subsequent research in similar Transformer-based sequence modeling. Architecture of a Transformer model typically is a neural network with transformer blocks/layers, which include self-attention layers, feed-forward layers, and normalization layers. The Transformer model learns context and meaning by tracking relationships in sequential data. Some large scale language models (LLMs) are based on the Transformer architecture.

With Transformer-based LLMs, the meaning of model training has expanded to encompass pre-training and fine-tuning. In pre-training, the LLM is trained on a large training dataset for the general task of generating an output sequence based on predicting a next sequence of tokens. In fine-tuning, various techniques are used to fine-tune the training of the pre-trained LLM to a particular task. For instance, a training dataset of examples that pair prompts and responses/predictions are input into a pre-trained LLM to fine-tune it. Prompt-tuning and prompt engineering of LLMs have also been introduced as lightweight alternatives to fine-tuning. Prompt engineering can be leveraged when a smaller dataset is available for tailoring an LLM to a particular task (e.g., via few-shot prompting) or when limited computing resources are available. In prompt engineering, additional context may be fed to the LLM in prompts that guide the LLM as to the desired outputs for the task without retraining the entire LLM.

Online Transaction Processing (OLTP) is a methodology for storage of user-related data and fast (“online”) user interaction to retrieve and present said data. OLTP is characterized by real-time resolution of user transactions with possibly multiple databases, typically relational databases, and simple user queries.

### BRIEF DESCRIPTION OF THE DRAWINGS

Embodiments of the disclosure may be better understood by referencing the accompanying drawings.

FIG. 1 is a schematic diagram of an example system for cybersecurity alert resolution with large language models based on user personas and natural language descriptors of alerts.

FIG. 2 is a conceptual diagram of an example conversation between a LLM and a user for cybersecurity alert resolution.

FIG. 3 is a flowchart of example operations for generating and storing persona-based natural language descriptors for detected alerts.

FIG. 4 is a flowchart of example operations for establishing a conversation with a user for cybersecurity alert resolution with natural language descriptors and an LLM.

FIG. 5 is a flowchart of example operations for generating a prompt for an LLM to respond to a user query based on natural language descriptor(s) of alert(s).

FIG. 6 depicts an example computer system with an alert detection system, a text converter, a persona classifier, a prompt generator, and a language model for facilitating user resolution of cybersecurity alerts by leveraging natural language descriptors of alerts.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Typical OLTP systems, due to the operational constraint of fast response times, can only handle simple queries and as such have rigidity in the scope of supported transactions. Users of these systems are not able to ask the breadth of questions that they might otherwise want to or be able to ask, for instance when discussing with a domain-level expert. The present disclosure leverages LLMs to allow for unconstrained user queries applicable to cybersecurity resources of an organization. As cybersecurity alerts are detected across the organization, a detection system logs the alerts as formatted descriptors in a structured data format such as a JavaScript® Object Notation (JSON) file. A text converter then converts each alert log into multiple natural language descriptors corresponding to different user personas for the organization. Each natural language descriptor is generated from a template for a corresponding persona by inserting metadata fields from the alert log that are applicable to the persona into the template. The natural language descriptors are stored in a descriptor database that supports efficient lookup based on resource identifiers, user personas, alert timestamps, etc.

In response to a query related to cybersecurity alerts from a user through an interface (e.g., a user interface), a classifier determines a persona of the user based on historical chat logs of the user. The classifier then queries the descriptor database with scoping parameters comprising the user/persona and other metadata for alerts corresponding to the user query. A prompt generator generates a prompt from natural language descriptors returned by the descriptor database that instructs the LLM to respond to the user query using information included in natural language descriptors. The LLM is configured to handle a long context window/input size (e.g., 100,000 tokens), and, in instances where many natural language descriptors and/or long natural language descriptors are returned by the database, a MapReduce module can shorten the prompt into truncated prompts to sequentially prompt to the LLM. The prompt generator can additionally enforce differential privacy across the organization by removing natural language descriptors for alerts with higher security privileges than the user (e.g., as indicated by the original alert log) from the prompt. Once the LLM is prompted by a generated prompt, the LLM establishes a conversation with the user via an interface (e.g., via a user interface) through which the user can ask the LLM about any issues related to the alerts to facilitate alert resolution. This pipeline for generating and prompting LLMs on natural language descriptors allows for unconstrained conversational alert resolution for users with reusable language models having low training costs.

### Example Illustrations

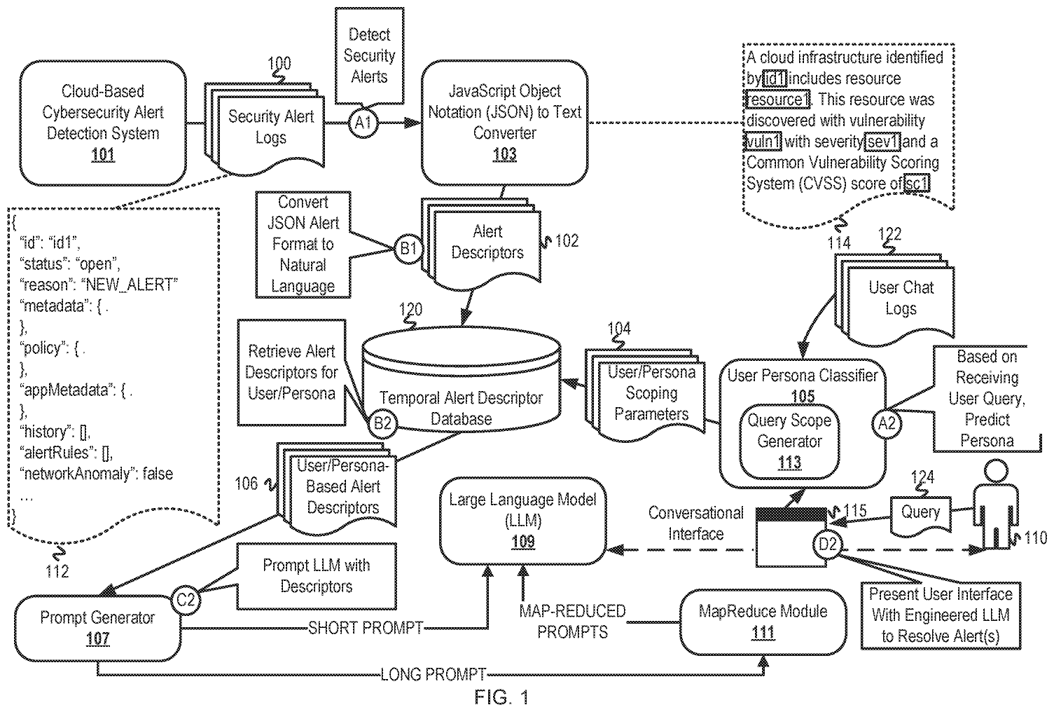

FIG. 1 is a schematic diagram of an example system for cybersecurity alert resolution with large language models based on user personas and natural language descriptors of alerts. A cloud-based cybersecurity alert detection system (detection system) 101 detects alerts at one or more resources for an organization and, as alerts are detected, communicates security alert logs 100 to a JSON to text converter (converter) 103. The text converter 103 converts security alert logs 100 to alert descriptors 102 according to alert templates for various user personas and communicates the alert descriptors 102 to a temporal alert descriptor database (“descriptor database”) 120 to store for subsequent user interactions. When a user 110 communicates a query 124 to a conversational interface 115, a user persona classifier 105 determines a persona for the user 110 and user/persona scoping parameters 104 corresponding to the user 110 and the query 124 and communicates the user/persona scoping parameters 104 to the descriptor database 120. The descriptor database 120 returns relevant user/persona-based alert descriptors 106 to a prompt generator 107 which generates a prompt(s) for an LLM 109.

The prompt generator 107 generates either a single prompt when the user/persona-based alert descriptors 106 are below a threshold length, or multiple prompts via a MapReduce module 111 when the user/persona-based alert descriptors 106 are above the threshold length. Once prompted, the LLM 109 subsequently converses with the user 110 for alert resolution via the conversational interface 115.

FIG. 1 is annotated with a series of numbers/letters A1, B1, A2, B2, C2, and D2. Each stage represents one or more operations. Operations at stages A1 and B1 are in a separate pipeline from operations at stages A2, B2, and C2. The former pipeline is triggered in response to an alert being logged by the detection system 101, while the latter pipeline is triggered by a query from a user 110 for alert resolution. Although these stages are ordered for this example, the stages illustrate one example to aid in understanding this disclosure and should not be used to limit the claims. Subject matter falling within the scope of the claims can vary from what is illustrated.

At stage A1, the detection system 101 detects and logs security alerts for resources of the organization and communicates the security alert logs 100 to the text converter 103. Each of the security alert logs 100 is a formatted descriptor that comprises metadata related to corresponding alerts such as metadata indicated in example log 112. The example log 112 has a JSON format and comprises an alert identifier attribute with value “id1”, an alert status attribute with value “open”, an alert reason value with attribute “NEW_ALERT”, an alert metadata list, a policy metadata list, an application metadata list, a history attribute, an alert rules attribute, and a network anomaly attribute with value “false”. Additional attributes can comprise compliance standards attributes, application context attributes, resource metadata attributes, etc. Application metadata and application context can be generated by an analysis module (not depicted) monitoring sessions and flows across the organization to isolate certain applications relevant to certain types of alerts.

At stage B1, the text converter 103 converts the security alert logs 100 into alert descriptors 102. Each alert descriptor 102 comprises a natural language descriptor of a corresponding alert log in the security alert logs 100 having metadata corresponding to a distinct user persona. User personas can include vulnerability operator, DevSecOps, SecOps, threat hunter, compliance, and chief information security officer (CISO). Each alert log is converted into a natural language descriptor for every persona, although in some embodiments the text converter 103 can convert an alert log only into a subset of user personas. For instance, when an alert log has a security privilege that is not accessible by one or more user personas, the text converter 103 can omit generating natural language descriptors for those user personas during conversion.

The text converter 103 stores a template for each user persona, each template comprising natural language and interspersed fields to copy from the security alert logs 100. Example alert descriptor 114 comprises the text “A cloud infrastructure identified by id1 includes resource resource1. This resource was discovered with vulnerability vuln1 with severity sev1 and a Common Vulnerability Scoring System (CVSS) score of sc1.” Boxed tokens in the example alert descriptor 114 including “id1”, “resource1”, “vuln1”, “sev1”, and “sc1” indicate tokens that were extracted and inserted into a corresponding template from a corresponding alert log. These values were placeholders in the original template. The example alert descriptor 114 is for the vulnerability operator persona. Subsequent to generating the alert descriptors 102, the text converter 103 communicates the alert descriptors 102 to the descriptor database 120 for storage. The descriptor database 120 stores a corpus of natural language descriptors across an organization. The descriptor database 120 can delete old natural language descriptors according to a schedule, for instance according to a schedule (e.g., every day) the descriptor database 120 can remove natural language descriptors that are more than a month old. Although the text converter 103 is depicted in FIG. 1 as generating natural language descriptors from JSON files logged from alerts, the text converter 103 can generate natural language descriptors from any formatted descriptors, for instance YAML files. Templates implemented by the text converter 103 can be periodically updated as additional personas are associated with the organization, as templates are refined based on quality of LLMs prompted by prompts generated by the templates, etc.

In a distinct pipeline operating in parallel to generating and storing natural language descriptors of alerts, at stage A2 a conversational interface 115 receives the query 124 from the user 110. The conversational interface 115 is an interface designed for alert resolution, and the query 124 indicates metadata related to alerts such as a time period, one or more resources, etc. from which to retrieve alert data. The conversational interface 115 communicates the query 124 to the user persona classifier 105, and the user persona classifier 105 predicts a user persona and, from the predicted user persona and the query 124, determines the user/persona scoping parameters 104 that will indicate natural language descriptors to retrieve from the descriptor database 120.

The user persona classifier 105 predicts the persona of the user 110 based on user chat logs 122. To exemplify, the user persona classifier 105 can extract entities from the user chat logs 122 (e.g., with named entity recognition), generate natural language features from the extracted entities, and input the natural language features into a regression model (e.g., a logistic regression model) to obtain confidence values of the user 110 being each persona as output. The predicted persona for the user 110 then comprises the persona corresponding to a highest confidence value in the output. The regression model can be trained on sets of natural language features for historical chat logs of users having labels of their known personas. The user persona classifier 105 can store a user's predicted persona and subsequently retrieve the stored persona rather than predicting the persona again. In some embodiments, users of the organization are instructed to manually identify their persona.

A query scope generator 113 identifies parameters pertaining to alerts based on the query 124 to include in the user/persona scoping parameters 104. These parameters can comprise resources identified by the query 124, time periods identified by the query 124, etc. The query scope generator 113 can also perform named-entity recognition on the query 124 to identify certain entities (e.g., resources) to include in the user/persona scoping parameters 104. The user/persona scoping parameters 104 can thus comprise a user persona, a time period, a list of resources, and any other parameters relevant to narrow the natural language descriptors to be used for prompting. The time period can additionally be tuned by the user 110 as an optional feature or be capped based on a max lookback period according to product retention policies (e.g., policies defined by products associated with alerts). The time period can be optimized to reduce overall storage in the descriptor database 120 based on heuristics, for instance by determining that users only care about data from within a week unless a high-severity cybersecurity incident (e.g., a data breach) has occurred. The user persona classifier 105 communicates the user/persona scoping parameters 104 to the descriptor database 120.

At stage B2, the descriptor database 120 retrieves the user/persona-based alert descriptors 106 corresponding to the user/persona scoping parameters 104. The descriptor database 120 can have a database architecture that allows for efficient lookup based on potential sets of parameters included in the user/persona scoping parameters 104 (e.g., efficient lookup based on time constraints). As a default, unless otherwise specified by the user/persona scoping parameters 104, the descriptor database 120 can search for alert descriptors within a relative timeframe such as the past month, week, etc. The descriptor database 120 communicates the user/persona-based alert descriptors 106 to the prompt generator 107. Both the user/persona scoping parameters 104 and the user/persona-based alert descriptors 106 comprise indications of the query 124 to be included during prompt generation. The descriptor database 120 and/or prompt generator 107 can remove natural language descriptors in the user/persona-based alert descriptors 106 having higher security privileges than the user 110. For instance, the descriptor database 120 and/or prompt generator 107 can remove natural language descriptors that describe sensitive customer data only accessible to a certain team within the organization or pertain to resources only accessible at an executive level of the organization. Removal of natural language descriptors enforces differential privacy. Each descriptor stored in the descriptor database 120 can have an associated security level (e.g., generated from an alert log for the descriptor), and each user can have a security level indicated by the organization.

At stage C2, the prompt generator 107 generates a prompt(s) for the LLM 109 based on the user/persona-based alert descriptors 106 and the query 124. The prompt comprises instructions to the LLM 109 that indicate the LLM 109 should answer the query 124 using information included in the user/persona-based alert descriptors 106. When there are many and/or long user/persona-based alert descriptors 106, resulting in a long prompt (e.g., more than 100,000 tokens) above a threshold length, the prompt generator 107 communicates the prompt to a MapReduce module 111 which splits up the prompt with a MapReduce program and sequentially communicates each of the map-reduced prompts to the LLM 109. Otherwise, for shorter prompts below the threshold length, the prompt generator 107 communicates the prompt to the LLM 109. Longer prompts results in a latency in prompting the LLM 109, and the conversational interface 115 can communicate an indication to the user 110 that responses to queries will have an initial delay.

At stage D2, the conversational interface 115 establishes a conversation between the LLM 109 to the user 110 (as indicated by the dotted line in FIG. 1) to resolve any alert(s) corresponding to the query 124. For instance, the conversational interface 115 can be presented as a chat box to the user 110. The conversational interface 115 allows for the user 110 to submit any natural language queries related to the alert(s), allowing for more query flexibility than a traditional OLTP system for alert resolution.

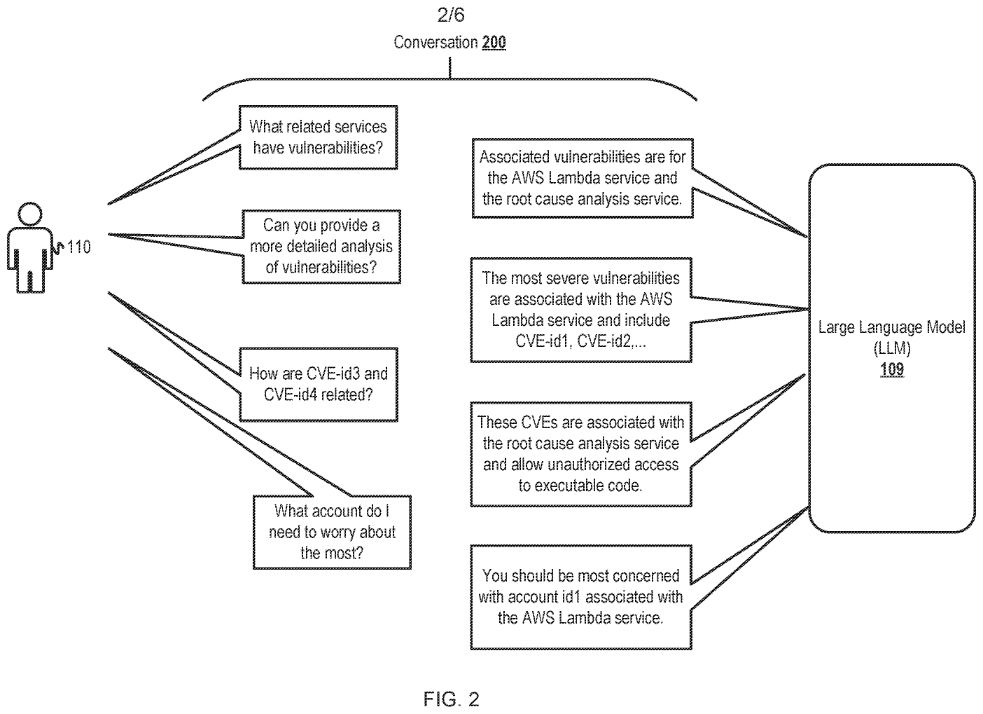

FIG. 2 is a conceptual diagram of an example conversation between a LLM and a user for cybersecurity alert resolution. FIG. 2 depicts the user 110 and the LLM 109 from FIG. 1 as actors in the conversation. FIG. 2 assumes that the LLM 109 has previously been prompted with a prompt generated from natural language descriptors of an alert related to the user 110. A conversation 200 between the user 110 and the LLM 109 comprises the following dialogue:
User: What related services have vulnerabilities?
LLM: Associated vulnerabilities are for the AWS Lambda service and the root cause analysis service.
User: Can you provide a more detailed analysis of vulnerabilities?
LLM: The most severe vulnerabilities are associated with the AWS Lambda service and include CVE-id1, CVE-id2, . . .
User: How are CVE-id3 and CVE-id4 related?
LLM: These CVEs are associated with the root cause analysis service and allow unauthorized access to executable code.
User: What account do I need to worry about the most?
LLM: You should be most concerned with account id1 associated with the AWS Lambda service.

The LLM 109 was previously prompted and/or tuned by a prompt that is generated to have knowledge of CVEs id1, id2, id3, id4 and their associations with the AWS Lambda service and the root cause analysis service from natural language descriptors of a corresponding alert(s) included in the prompt. The LLM 109 is able to reply to natural language user queries that impose their own logic on what information to retrieve from the natural language descriptors, for instance by correlating vulnerabilities with each other and by determining a most compromised account based on vulnerability data across accounts.

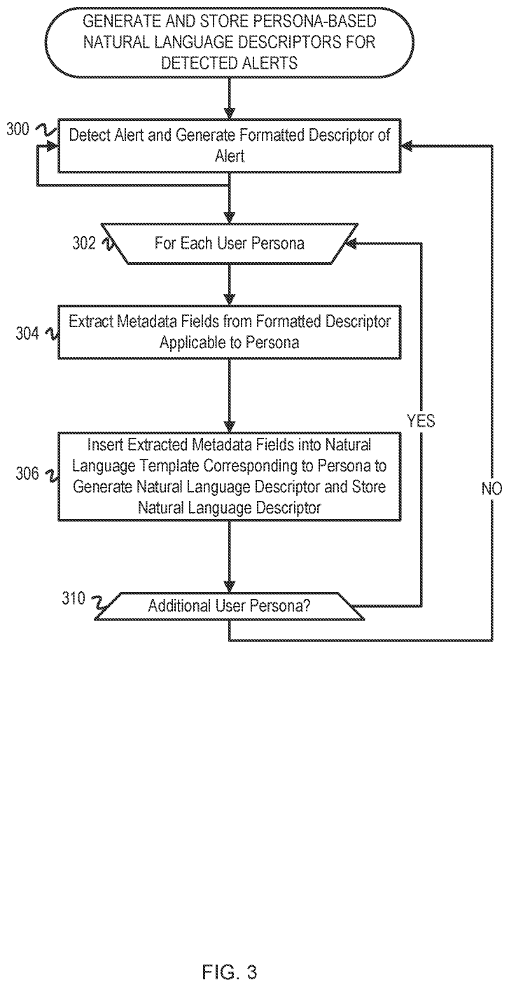

FIGS. 3-5 are flowcharts of example operations for generating and storing natural language descriptors of alerts and using the natural language descriptors to generate prompts for an LLM that establishes a conversation with a user via an interface for alert resolution. The example operations are described with reference to a detection system, a text converter, a persona classifier, a prompt generator, and an LLM for consistency with the earlier figures and/or ease of understanding. The names chosen for example program code are not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for generating and storing persona-based natural language descriptors for detected alerts. At block 300, a detection system detects alerts and generates formatted descriptors of alerts. The alerts comprise cybersecurity alerts, for instance cybersecurity alerts detected by firewalls and/or services deployed at resources across an organization. The formatted descriptors comprise metadata fields stored in a file format (e.g., JSON files) according to a standardized format for logging alerts across the organization. The formatted descriptors can indicate resource identifiers, status identifiers, alert reasons, alert metadata, policy metadata for a corresponding resource(s), application metadata for applications related to the alert, history metadata for the resource, security compliance metadata, etc. Block 300 is depicted with a returning line to indicate that the detection system logs formatted descriptors of alerts as they are detected across the organization continuously and in parallel with the remaining operations in FIG. 3 until an external trigger (e.g., termination of the detection system by an administrator) occurs. FIG. 3 refers to storage of formatted descriptors (i.e., alert logs) and natural language descriptors. The formatted descriptors can be stored and maintained in a separate database from a database storing the natural language descriptors, and each database can have separate architectures/lookup configurations and separate configurations for removing outdated descriptors.

At block 302, a text converter begins iterating through user personas. The user personas correspond to an organization for which the detection system generates formatted descriptors of alerts. The user personas and metadata characteristics of the user personas can be identified by a domain-level expert according to characteristics of users who perform cybersecurity alert resolution for the organization. Example personas include vulnerability operator, DevSecOps, SecOps, threat hunter, compliance, CISO, etc.

At block 304, the text converter extracts metadata fields from the formatted descriptor applicable to the persona at the current iteration. The metadata fields comprise fields to include in a natural language template for the persona. The formatted descriptor can indicate each applicable field according to its file format. For instance, a JSON file can indicate the type of field as an attribute in an attribute/value pair or as a list, and the text converter can match the attribute/list to a list of types of fields for the persona and extract the corresponding value(s) to include in the natural language template.

At block 306, the text converter inserts the extracted metadata fields into a natural language template corresponding to the persona to generate a natural language descriptor. The template comprises a description of the alert using natural language with blank fields matching corresponding extracted fields. Each template corresponds to an individual persona. In some embodiments, there can be multiple templates for a single persona when the user corresponding to that persona has different security privileges, for instance to remove certain fields in the template that have higher security privileges than the user. In other embodiments, when one or more of the blank fields were not present in the formatted descriptor during extraction, the text converter can insert a placeholder field or replace/remove the natural language description surrounding the field. A domain-level expert can periodically update/add natural language templates as more personas are identified for the one or more organizations and as quality of prompt engineering for LLM prompts using the natural language templates is evaluated (e.g., by evaluating quality of responses to user queries by LLMs). A descriptor database stores the natural language descriptor. The natural language descriptor is stored in association with metadata for the alert indicated in the formatted descriptor, for instance an alert timestamp, identifiers of associated resources, the persona, etc.

At block 310, the text converter determines if there is an additional user persona. If there is an additional user persona, operational flow returns to block 302. Otherwise, operational flow returns to block 300 for additional alert detection and generation of formatted descriptors for alerts, although as previously noted these operations occur outside of the flow depicted at blocks 302, 304, 306, 308, and 310.

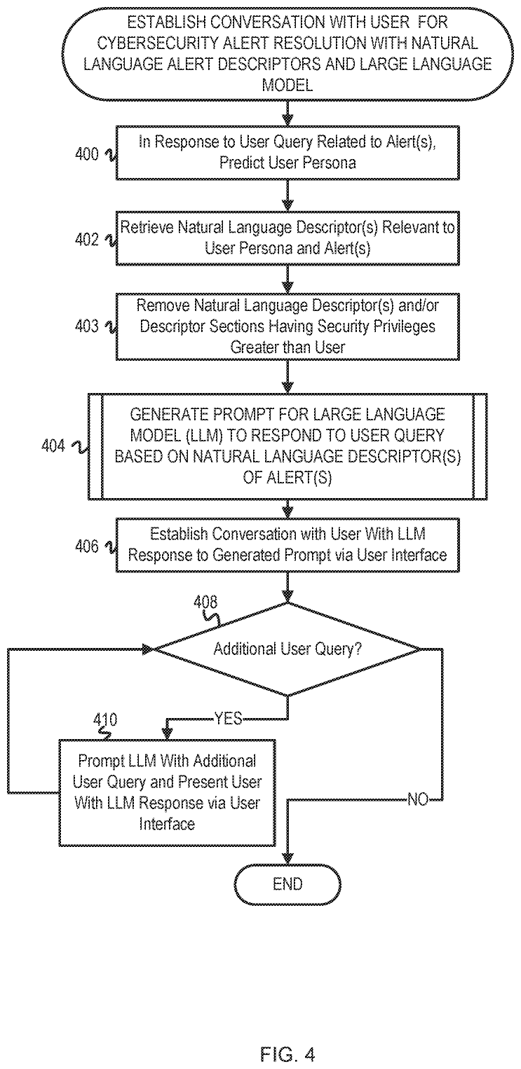

FIG. 4 is a flowchart of example operations for establishing a conversation with a user for cybersecurity alert resolution with natural language descriptors and an LLM. The operations in FIG. 4 assume that natural language descriptors for an alert(s) related to a user have previously been generated and stored according to varying potential personas of a user querying for alert resolution. For embodiments where no alerts have been detected in a context (e.g., recent time frame and at associated resources) of the user, in response to the querying, the user can be presented with an indication of lack of alerts instead of performing the operations depicted in FIG. 4. Although depicted as occurring based on a user query related to alerts, in other embodiments the operations in FIG. 4 can occur in response to detecting an alert and presenting the user with indications/descriptions of the alert. Based on detecting an alert, the operations can be performed for all users associated with the alert.

At block 400, in response to a user query related to an alert(s), a persona classifier predicts a persona of the user. To illustrate, the personal classifier can comprise a logistic regression model that outputs confidence values of the user having each persona, and the predicted persona can comprise the persona with highest confidence value (with ties broken randomly). The logistic regression model can receive feature vectors generated from historical chat logs of the user as input. For instance, the feature vectors can be generated using natural language embeddings of historical user chat logs. The logistic regression model can be trained on feature vectors of historical chat logs for users with known personas.

At block 402, the persona classifier retrieves a natural language descriptor(s) relevant to the user persona and alert(s) and communicates the natural language descriptor(s) to a prompt generator. The persona classifier determines scoping parameters corresponding to the user persona and alert(s) that determine which natural language descriptor(s) to retrieve. The scoping parameters indicate resource identifiers, the predicted persona, query timestamps, etc. For instance, the scoping parameters can be extracted from data stored by the organization for the user or resources associated with the user. The scoping parameters can additionally depend on entities indicated in the use query such as resources, vulnerabilities, etc. The persona classifier queries a descriptor database with the scoping parameters to retrieve the natural language descriptor(s). In some embodiments, unless otherwise indicated by the scoping parameters and/or specified by the user, the descriptor database can be configured to return natural language descriptor(s) for alerts within a time period (e.g., past 30 days) from the timestamps in the scoping parameters. The time period can be a default time period based on retention policies for corresponding products (e.g., products deployed on resources indicated in the user query) The time periods can additionally be optimized based on heuristics that track typical user activity and use cases, for instance to determine that users typically do not act upon alerts more than a week old. Prior to subsequent operations for generating a prompt and prompting the LLM to present to the user, the prompt generator or other component/module can present the user with a summary of alerts returned by the descriptor database related to their user query as a precursor to responding to user queries.

At block 403, the persona classifier or descriptor database removes natural language descriptors and/or descriptor sections with security privileges above those of the user. The persona classifier or descriptor database can determine security privileges of the user based on user metadata and security privileges of the natural language descriptors from metadata of formatted descriptors from which they were generated. Each descriptor section and/or descriptor can have associated security privileges, and the persona classifier or descriptor database can remove those descriptors/sections associated with higher security privileges than the user. The removal of natural language descriptors enforces differential privacy across the organization. For instance, natural language descriptors can describe alerts for privileged resources only accessible to the organization's executives. Other natural language descriptors can comprise alerts for resources that store confidential information (e.g., client data) that is only accessible to certain teams in the organization working with that confidential information.

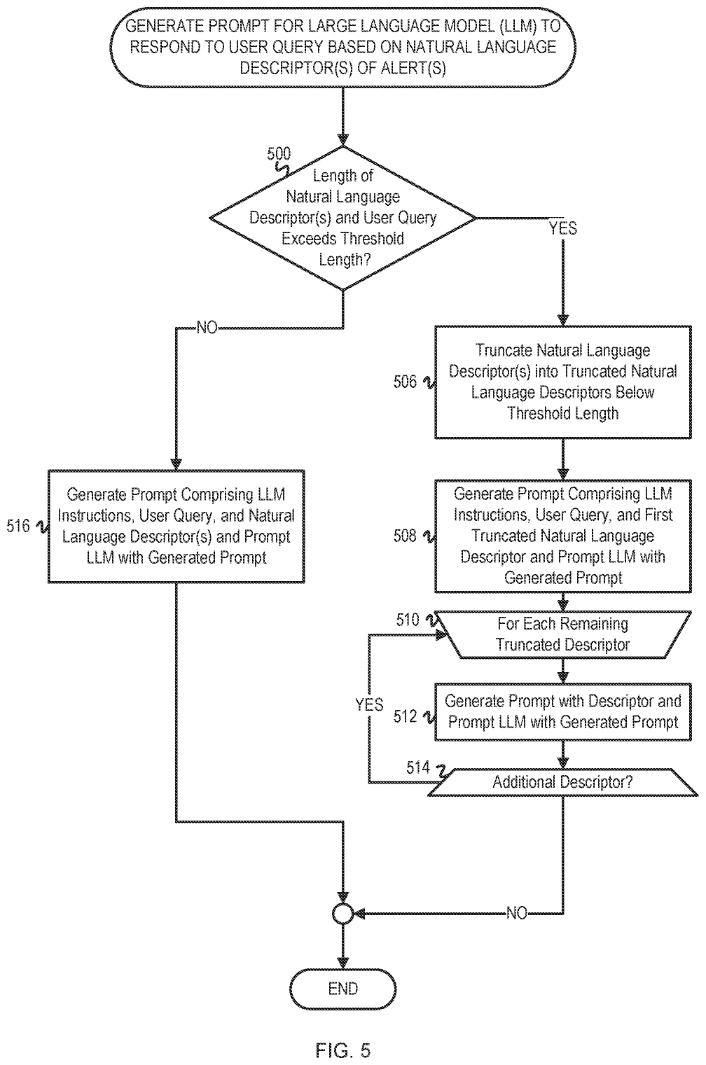

At block 404, the prompt generator prompts an LLM with a generated prompt based on the natural language descriptor(s) of the alert(s) so that the LLM can respond to the user query. Operations at block 404 are described in greater detail in reference to FIG. 5.

At block 406, the prompt generator establishes a conversation with the user with the response of the LLM to the generated prompt at block 404 via a user interface or other interface accessible to the user. Subsequently, the user can provide additional queries to the LLM via the interface. At block 408, if there is an additional query from the user, operational flow proceeds to block 410. Otherwise, the operational flow is complete. The interface can have an internal clock that times out (e.g., every 5 minutes) based on the user failing to communicate an additional query via the interface. Alternatively, the interface can be configured to shut down when the user exits an application associated with the interface. The LLM can be stored in a cache in case the user communicates an additional query in the future after a timeout or exiting an application.

At block 410, the user interface prompts the LLM with the additional user query and presents the user with the LLM response via the user interface. The LLM has prior conversational context of the initial LLM response, providing access to alert data for answering user queries. As the user continues to query the LLM, the LLM learns conversational context of the user queries to inform future user queries. To exemplify, if a first user query comprises “what vulnerabilities are highest severity for exposing resource id1” and a second user query comprises “correlate those vulnerabilities with vulnerabilities for resource id2”, the LLM would have conversional knowledge that “those vulnerabilities” from the first user query are the vulnerabilities with highest severity for resource id1 from the first user query. Operational flow returns to block 406.

FIG. 5 is a flowchart of example operations for generating a prompt for an LLM to respond to a user query based on a natural language descriptor(s) of an alert(s). The natural language descriptor(s) comprises a descriptor of an alert(s) related to a user that communicated the user query as well as resources associated with the user and a timestamp when the user communicated the user query.

At block 500, a prompt generator determines whether a length of the natural language descriptor(s) and the user query exceeds a threshold length. The length to compare to the threshold length is computed based on the language of a generated prompt that would be generated based on the natural language descriptor(s) and user query, e.g., according to a prompt template. The threshold length can be a maximal input length for the LLM (e.g., 100k tokens). The threshold length can be computed as a number of tokens rather than just characters since tokens in the natural language descriptor(s) and user query can be converted into natural language embeddings prior to inputting into the LLM. The LLM can have an architecture such as Anima LLM that can accept long input lengths. If the length of the natural language descriptor(s) and user query does not exceed the threshold length, operational flow proceeds to block 516. Otherwise, operational flow proceeds to block 506.

At block 506, the prompt generator truncates the natural language descriptor(s) into truncated natural language descriptors each below the threshold length. Truncation length depends on a template for prompt generation and length of the user query. For instance, a first truncated natural language descriptor can comprise instructions for the LLM, the user query, and a truncated natural language descriptor, while the remaining truncated natural language descriptors can comprise truncations of the natural language descriptors themselves. As an illustrative example, consider when the instructions length is 500 tokens, the user query length is 500 tokens, the natural language descriptors are 200k tokens, and the maximal input length to the LLM is 100k tokens. The total number of tokens is thus 210k tokens against the maximal input length of 100k tokens. To fit everything under this 100k token length, the first truncated natural language descriptor can comprise the instructions, the user query, and the first 99k tokens of the natural language descriptors for a total of 100k tokens, the second truncated natural language descriptor can comprise the next 100k tokens of the natural language descriptors, and the third truncated natural language descriptor can comprise the remaining 1k tokens of the natural language descriptors. Truncation and storage of natural language descriptors can be optimized for efficiency when there are high loads of tokens in natural language descriptors, for instance by using a MapReduce program. The use of “truncating” is a simplified expression for possibly more complex architectures for data storage, splitting, combining, reducing, etc. to optimize the operation of generating reduced length inputs to the LLM.

At block 508, the prompt generator generates a prompt comprising instructions for the LLM, the user query, and the first truncated natural language descriptor and prompts the LLM with the generated prompt. The instructions for the LLM indicate that the LLM should answer the user query and additional user queries using available data from the first truncated natural language descriptor and any additional data from subsequent natural language descriptors. The generated prompt can further indicate instructions that there are additional natural language descriptors in prompts that follow.

At block 510, the prompt generator begins iterating through truncated descriptors. At block 512, the prompt generator generates a prompt with the current truncated descriptor and prompts the LLM with the generated prompt. The generated prompt includes the current truncated descriptor and can further indicate that there are additional descriptors if present. At block 514, the prompt generator continues iterating through truncated descriptors. If there is an additional truncated descriptor, operational flow returns to block 510. Otherwise, operational flow in FIG. 5 is complete.

At block 516, the prompt generator generates a prompt comprising instructions for the LLM, the user query, and the natural language descriptor(s) and prompts the LLM with the generated prompt. The LLM instructions can indicate to the LLM that the user query is related to vulnerability analysis and can further indicate relevant industry information important to analyzing the natural language descriptor(s) based on the user query, for instance describing how vulnerabilities are classified, how alerts are detected and logged, how vulnerabilities relate to resources and services running on resources, etc.

### Variations

The foregoing operations describe generating prompts using natural language descriptors of alerts and prompting LLMs so that they can interface with a user for alert resolution. Alternatively, the natural language descriptors can be used to train, tune, and/or prompt any language model able to interface with a user to respond to user queries and learn conversational context from past user queries. The language model can be a language model pretrained on general language tasks and, in some embodiments, can be further trained or tuned for the context of cybersecurity alert resolution. Although described as generating a prompt and prompting an LLM, any type of training/tuning based on natural language descriptors can be implemented. “Tuning” can refer to prompt generating and prompting language models with the generated prompts or any other additional training operations related to language models and natural language descriptors. LLMs can be reused across users and can maintain knowledge of prior conversations and prior generated prompts for past resolution of multiple alerts related to multiple users.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 3 can be performed in parallel or concurrently with the operations depicted in FIGS. 4 and 5. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

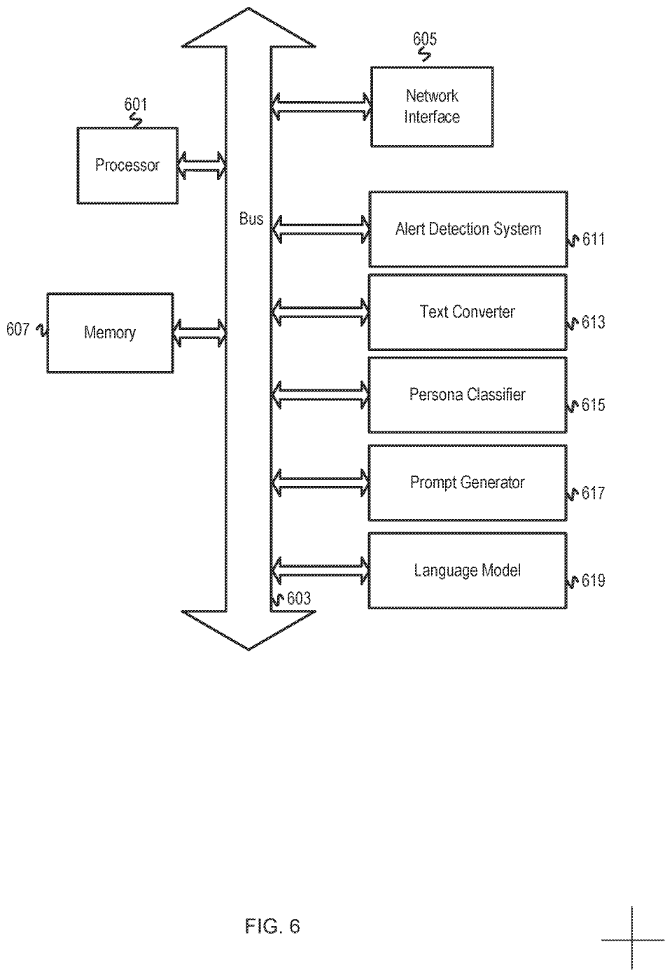

FIG. 6 depicts an example computer system with an alert detection system, a text converter, a persona classifier, a prompt generator, and a language model for facilitating user resolution of cybersecurity alerts by leveraging natural language descriptors of alerts. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes an alert detection system 611, a text converter 613, a persona classifier 615, a prompt generator 617, and a language model 619. The alert detection system 611 detects and logs formatted descriptors of cybersecurity alerts related to vulnerabilities of an organization. A text converter 613 converts the formatted descriptors into natural language descriptors for various personas of the organization using templates for each persona by inserting metadata fields from the formatted descriptors into the templates and stores the natural language descriptors in a descriptor database (not depicted for simplicity). Based on detecting a user query, possibly in response to notifying a user of one or more of the detected alerts, a persona classifier 615 predicts a persona of the user based on historical chat logs and retrieves natural language descriptors relevant to the user/persona as well as additional parameters such as a timestamp of the user query from the descriptor database. A prompt generator 617 generates one or more prompts (after truncating the natural language descriptors and user query if they exceed a threshold length) and prompts a language model 619 with the generated prompt(s). The language model 619 is presented via an interface with the user for alert resolution. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
based on detecting a user query, predicting a persona from a plurality of personas for a user associated with the user query;
retrieving a natural language descriptor of a security alert corresponding to the user query and the predicted persona, wherein the natural language descriptor indicates first metadata applicable to the predicted persona logged in a formatted descriptor generated for the security alert;
tuning a language model with the natural language descriptor; and
establishing a conversation between the language model and the user via an interface with the user for resolution of the security alert.

2. The method of claim 1 further comprising:
generating a formatted descriptor of the security alert indicating second metadata of the security alert applicable to the plurality of personas;
for each persona, generating a first plurality of natural language descriptors based on the formatted descriptor each corresponding to one of the plurality of personas, wherein the first plurality of natural language descriptors comprises the natural language descriptor; and
storing the first plurality of natural language descriptors in association with corresponding ones of the plurality of personas.

3. The method of claim 2, wherein generating the first plurality of natural language descriptors comprises inserting third metadata indicated by the formatted descriptor into templates for corresponding ones of the plurality of personas.

4. The method of claim 1, wherein interfacing the language model with the user for resolution of the security alert comprises:
notifying the user of the security alert; and
for each user query of a sequence of user queries communicated from the user in response to the notification,
prompting the language model with the user query to obtain a response to the user, wherein the response indicates at least a subset of the first metadata applicable to the predicted persona, wherein the user query comprises a natural language query for data related to the security alert; and
communicating the response to the user.

5. The method of claim 1, wherein predicting the persona for the user comprises:
generating natural language features from chat logs of the user; and
inputting the natural language features into a logistic regression model to obtain the predicted persona as output.

6. The method of claim 1, wherein the language model comprises a large language model.

7. The method of claim 6, wherein tuning the language model comprises prompting the language model with at least the natural language descriptor and the user query.

8. The method of claim 1, further comprising, based on determining that the natural language descriptor exceeds a threshold length, truncating the natural language descriptor into a second plurality of natural language descriptors below the threshold length, wherein tuning the language model with the natural language descriptor comprises serialized tuning the language model with the second plurality of natural language descriptors.

9. The method of claim 8, wherein truncating the natural language descriptor comprises processing the natural language descriptor with a MapReduce program.

10. The method of claim 1, further comprising, prior to tuning the language model:
identifying a subset of the natural language descriptor with security privileges exceeding security privileges of the user; and
removing the subset of the natural language descriptor from the natural language descriptor.

11. A non-transitory machine-readable medium having program code stored thereon, the program code comprising instructions to:
based on detecting security alerts, generate natural language descriptors of the security alerts from corresponding formatted descriptors logged for the security alerts, wherein the natural language descriptors indicate metadata in the formatted descriptors applicable to corresponding personas in a plurality of personas; and
based on receiving a query from a user associated with at least a subset of the detected security alerts, predict a persona from the plurality of personas for the user;
retrieve one or more natural language descriptors for a subset of the detected security alerts corresponding to at least the user and the predicted persona; and
tune a language model to interface with the user for resolution of the subset of the detected security alerts using the one or more natural language descriptors.

12. The non-transitory machine-readable medium of claim 11, wherein the instructions to generate the natural language descriptors comprises instructions to insert the metadata in the formatted descriptor into templates for corresponding ones of the plurality of personas.

13. The non-transitory machine-readable medium of claim 11, wherein the program code to interface the language model with the user for resolution of the subset of the detected security alerts comprises instructions to:
notify the user of the subset of the detected security alerts; and
for each user query of a sequence of user queries communicated from the user in response to the notification,
prompt the language model with the user query to obtain a response to the user, wherein the response indicates at least a subset of the metadata in the formatted descriptors applicable to the predicted persona for the user, wherein the user query comprises a natural language query for data related to the subset of the detected security alerts; and
communicate the response to the user.

14. The non-transitory machine-readable medium of claim 11, wherein the program code to predict the persona for the user comprises instructions to:
generate natural language features from chat logs of the user; and
input the natural language features into a logistic regression model to obtain the predicted persona as output.

15. The non-transitory machine-readable medium of claim 11, wherein the language model comprises a large language model, and wherein the program code to tune the language model comprises instructions to prompt the language model with at least the one or more natural language descriptors and the user query.

16. An apparatus comprising:
a processor; and
a machine-readable medium having instructions stored thereon that are executable by the processor to cause the apparatus to,
generate natural language descriptors of security alerts from corresponding formatted descriptors logged for the security alerts, wherein each natural language descriptor of the natural language descriptors of the security alerts indicates metadata in the corresponding formatted descriptor applicable to a persona in a plurality of personas; and
in response to a query from a user associated with at least a subset of the security alerts,
predicting a persona from the plurality of personas for the user;
retrieving one or more natural language descriptors for a subset of the security alerts corresponding to at least the user and the predicted persona; and
tuning a language model to interface with the user for resolution of the subset of the security alerts using the one or more natural language descriptors.

17. The apparatus of claim 16, wherein program code to generate the natural language descriptors comprise instructions executable by the processor to cause the apparatus to insert the metadata in the formatted descriptor into templates for corresponding ones of the plurality of personas.

18. The apparatus of claim 16, wherein the instructions to interface the language model with the user for resolution of the subset of the security alerts comprise instructions executable by the processor to cause the apparatus to:
notify the user of the subset of the security alerts; and
for each user query of a sequence of user queries communicated from the user in response to the notification,
prompt the language model with the user query to obtain a response to the user, wherein the response indicates at least a subset of the metadata in the formatted descriptors applicable to the predicted persona for the user, wherein the user query comprises a natural language query for data related to the subset of the security alerts; and
communicate the response to the user.

19. The apparatus of claim 16, wherein the instructions to predict the persona for the user comprise instructions executable by the processor to cause the apparatus to:
generate natural language features from chat logs of the user; and
input the natural language features into a logistic regression model to obtain the predicted persona as output.

20. The apparatus of claim 16, wherein the language model comprises a large language model and wherein the instructions to tune the language model comprise instructions executable by the processor to cause the apparatus to prompt the language model with at least the one or more natural language descriptors and the user query.
